(19) United States
(12) Patent Application Publication
(10) Pub. No.: US 2021/0207011 A1
(43) Pub. Date: Jul. 8, 2021

(54) COMPOSITIONS CONTAINING ISOCYANATE FUNCTIONAL PREPOLYMERS AND QUATERNARY AMMONUM MODIFIED NANOCLAYS

(71) Applicant: DOW GLOBAL TECHNOLOGIES LLC, Midland, MI (US)

(72) Inventors: Lirong Zhou, Rochester Hills, MI (US); Steve Allison, Midland, MI (US); Andrew R. Kneisel, Clarkston, MI (US)

(21) Appl. No.: 15/999,377

(22) PCT Filed: Feb. 3, 2017
(86) PCT No.: PCT/US2017/016369

§ 371 Date: Aug. 16, 2018

Related U.S. Application Data
(60) Provisional application No. 62/296,247, filed on Feb. 17, 2016.

(51) Int. Cl. C09J 175/08; C08G 18/79; C08G 18/30; C08G 18/12

(52) U.S. Cl. CPC C09J 175/08; C08G 18/792; C08K 9/04; C08G 18/12; C08G 18/307

(57) ABSTRACT

Disclosed are compositions containing isocyanate functional prepolymers, quaternary ammonium modified nanoclays and thixotropic fillers; adhesives based on such compositions; and methods for bonding substrates together utilizing the compositions.

### FIELD

Disclosed are compositions containing isocyanate functional prepolymers, quaternary ammonium modified nanoclays and optionally thixotropic fillers; adhesives based on such compositions; and methods for bonding substrates together utilizing the compositions.

### BACKGROUND

Compositions having isocyanate functional components are utilized in a variety of useful products such as adhesives, sealers, molded products and foams, which may be utilized in construction, vehicle manufacture, assembly of electronic subassemblies and devices, and toys. The adhesives have found widespread use because they provide reasonable processing conditions and exhibit good adhesion to many substrates, such as bonding windows into structures or parts to a structure. In automotive assembly plants windows are bonded in with one part adhesive compositions containing isocyanate functional components and a cure catalyst which cure as a result of exposure to moisture. The dispensing equipment for one part adhesives is less complex than the equipment used to apply two-part adhesives. One part moisture curing adhesives known in the art are disclosed in U.S. Pat. Nos. 4,374,237, 4,687,533, 4,780,520, 5,063,269, 5,623,044, 5,603,798, 5,852,137, 5,922,809, 5,976,305, 5,852,137 and 6,512,033, relevant portions incorporated herein by reference in their entirety for all purposes and examples include BETASEAL™ 15630, 15625, 61355 adhesives available from The Dow Chemical Company, EFBOND™ windshield adhesives available from Eftec, WS 151™, WS212™ adhesives available from Yokohama Rubber Company, and SIKAFLEX™ adhesives available from Sika.

Two-part polyisocyanate based adhesives comprise, in one part, a polyisocyanate or an isocyanate functional prepolymer and, in a second part, a curing agent and catalyst for the reaction. The two parts are contacted to start cure and cure much faster than one-part adhesives. Examples of such adhesive systems are disclosed in U.S. Pat. Nos. 7,892,395; 6,965,008; EP 1433802 and EP 1578834, all incorporated herein by reference in their entirety for all purposes. Two part adhesives can be used for bonding replacement windows into vehicles, bonding parts together or parts to structures.

In automobile factories windows are installed using robots and computer controlled processing which facilitates the use of a variety of high performance adhesives, for instance nonconductive adhesives and high modulus adhesives. The speed of cure is not a significant issue because new vehicles are not driven a significant distance for several days after window installation. Conversely, when a vehicle needs a window replaced, it is often performed in a remote location by an installer working from a vehicle. In this environment, speed of cure is important as the vehicle owner desires to drive the vehicle as soon as possible after installation of the window. Adhesives useful in replacing windows for vehicles which facilitate fast drive away times are known see Bhat, U.S. Pat. No. 5,976,305 and Zhou, U.S. Pat. No. 6,709,539, incorporated herein by reference in their entirety for all purposes. The introduction of various high performance adhesive compositions used for installing windows in automobile factories presents a problem for replacement window installers. Adhesives that meet all the varied performance requirements are not available in the market place. It is difficult to formulate many high performance adhesive compositions to allow rapid drive away times that do not sag or string. Sag is the loss of the shape of the adhesive bead, often as the result of gravitational forces. If severe enough, this deformation can interfere in the proper installation and sealing of the window into the vehicle. Stringing of an adhesive is the formation of a long string of adhesive at the end of the bead of adhesive dispensed which can complicate application of the adhesive and cause imperfections in the installed adhesive bead. A replacement window installer often has to carry a variety of adhesives to match the replacement adhesive to the properties of the original adhesive.

Adhesives have been developed which provide good initial green strength that allow adhesives to hold the glass in place without fixturing. This is achieved through the inclusion of crystalline polyesters in the adhesive which have hot melt properties requiring that the adhesive be melted and applied hot; Proebster, U.S. Pat. No. 5,747,581, incorporated herein by reference. The problem with these adhesives is that they require heat and complex equipment for their use. The initial green strength may not be sufficient for rapid drive away time. Because of the proliferation of hot melt adhesives in automobile window replacement, many installers insist on heating adhesives prior to applying the adhesive to the window or the window flange, which may exacerbate sagging and/or stringing.

Several approaches to providing high performance, such as non-conductive, adhesives including using non-conductive carbon black and polyester polyols in adhesive formulations are known U.S. Pat. No. 7,101,950. WO 02/053671 discloses the use of low or non-oxidized carbon black with polycarbonate based polyols to achieve this objective, incorporated herein by reference in their entirety for all purposes. The problem is that low conductive carbon black and polycarbonate polyols are significantly more expensive than standard grades of carbon black which are conductive and other polyols. Zhou US2006/0096694A1 discloses an adhesive which achieves a variety of high performance properties which contains polyester polyols and standard carbon black, incorporated herein by reference in their entirety for all purposes. The nonconductive properties are imparted by carefully limiting the amount of carbon black. The amount of carbon black impacts the rheological properties of the adhesive and thus the sag and stringiness of the adhesive. Polyester based isocyanate functional prepolymers are used to improve fixturing properties. As automotive designs have changed more robust adhesive systems are required. Polyester based isocyanate functional prepolymers can be shear sensitive and processing of adhesives containing them can negatively impact the properties of the adhesive and some of these adhesive systems may not be suitable for use with the new designs. A number of references have published that address this issue using a variety of formulation approaches to achieve fixturing and sufficient strength of an applied adhesive after 30 minutes to allow a vehicle to be driven safely, Golembowski U.S. Pat. No. 8,236,891 and Schmatloch WO 2014/179091, both incorporated herein by reference in their entirety for all purposes. The disclosed solutions meet the desired property requirements through the use of complex formulation chemistry which require relatively expensive starting materials and additional processing considerations. The market seeks solutions that can be used in one part adhesives using isocyanate functional prepolymers used widely in the market without the need to alter the process steps and equipment presently utilized to prepare these adhesives.

What is needed are compositions which are useful as adhesives for bonding glass into structures which may be formulated to exhibit a variety of high performance properties, exhibit fast safe drive away times when applied under a variety of conditions, for example after 30 minutes, fast strength development, which can be applied with or without heating the adhesive, can be applied under a wide range of environmental conditions, do not require expensive ingredients, do not sag or string when applied and exhibit improved shear sensitivity.

### SUMMARY

Disclosed are compositions comprising: a) one or more isocyanate functional prepolymers; b) one or more quaternary ammonium modified nanoclays; c) one or more catalysts for the reaction of isocyanate moieties with active hydrogen atom containing groups; and optionally one or more thixotropic fillers, for example fumed silica. The compositions may contain one or more forms of carbon black. The one or more forms of carbon black may comprise non-conductive carbon black, conductive carbon black, or a mixture thereof, wherein the conductive carbon black is present in an amount below the percolation threshold for the composition. The one or more nanoclays may comprise a mixture of nanoclays. The mixture of one of more nanoclays may contain smectite. The one or more nanoclays may have at least one dimension less than 100 nm.

The disclosure relates to a method of bonding two or more substrates together which comprises contacting the two or more substrates together with a composition as disclosed herein disposed along at least a portion of the area wherein the substrates are in contact. At least one of the substrates may be glass or a plastic coated with an abrasion resistant coating. One of the substrates may be metal or plastic, which may be coated or uncoated. The method disclosed may be performed where the composition exhibits a temperature at or near ambient temperature when applied to a substrate. The method disclosed may be performed where the composition exhibits a temperature a temperature of about 40 to about 80° C. when applied to a substrate.

The curable compositions may be used as an adhesive to bond substrates together, which may be similar and dissimilar, for instance, plastics, glass, wood, ceramics, metal, coated substrates and the like. They may be used to bond glass or trans-parent plastic structures to other substrates such as vehicles and buildings; and parts of modular components together, such as vehicle modular components. Structures bonded together utilizing the compositions disclosed herein remain bonded together for a sub-stantial portion or all of the structures useful life. Advantageously the composition is pumpable, sag and string resistant, bonds parts together, at temperatures from about −18° C. to about 80° C., or from about 20° C. to about 46° C. and are shear stable. The composition may exhibit a sag of an uncured sample of about 10 mm or less. This allows the adhesives prepared from compositions disclosed to be applied at a wide range of ambient temperatures. Heated application machinery is not necessary for the application of the compositions. The compositions demonstrate rapid strength development which may facilitate rapid drive away times of one hour, or 30 minutes, after application of the composition at temperatures of from about 0° F. (−18° C.) to about 115° F. (46° C.). Windshields installed under such conditions meet United States Federal Motor Vehicle Safety Standard (FMVSS) 212. The compositions may be nonconductive and demonstrate a dielectric constant of about 15 or less. The compositions may demonstrate a pendulum impact 30 minutes after application of about 5,000 milliJoules or greater or about 5,500 milliJoules or greater according to ASTM D256. The compositions disclosed exhibit a storage modulus, G′ of about 5.4 E+5 Pa or greater. Pumpability of the composition can be measured according to the press flow viscosity test described hereinafter; may exhibit a press flow viscosity when forced though an orifice of 0.203 in (5.16 mm) under pressure of about 5 to about 55 seconds at 23° C.+1-1° C.

### DETAILED DESCRIPTION

The explanations and illustrations presented herein are intended to acquaint others skilled in the art with the invention, its principles, and its practical application. The following claims are hereby incorporated by reference into this written description.

One or more means that at least one, or more than one, of the recited components may be used. Nominal with respect to functionality means the theoretical functionality; this can be calculated from the stoichiometry of the ingredients used. The actual functionality is different due to imperfections in raw materials, incomplete conversion of the reactants and formation of by-products. Isocyanate content means the weight percentage of isocyanate moieties based on the total weight of the prepolymer. The term isocyanate-reactive compound means any organic compound having nominally at least two isocyanate-reactive moieties, including active hydrogen containing moieties, and may refer to moieties containing a hydrogen atom which, because of its position in the molecule, displays significant activity according to the Zerewitinoff test described by Wohler in the Journal of the American Chemical Society, Vol. 49, p. 3181 (1927). Illustrative of such isocyanate reactive moieties, are —COOH, —OH, —NH₂, —NH—, —CONH₂, —SH, and —CONH—. Exemplary isocyanate reactive moiety containing compounds include polyols, polyamines, polymercaptans and polyacids, may include polyols, such as polyether polyols. Reactive means that the curable composition contains components which react to form a polymeric matrix that is set irreversibly once cured.

The compositions can be any reactive system containing isocyanate functional prepolymers, which may further comprise alkoxysilane groups. The reactive systems may be one or two-part systems, which may be useful as adhesives. Isocyanate based (polyurethane or polyurea forming) curable systems comprise one or more isocyanate functional prepolymers which contain on average more than one isocyanate functional group per molecule. An isocyanate prepolymer can be any prepolymer prepared by reaction of an isocyanate functional compound with one or more compounds having on average more than one isocyanate reactive functional moieties under conditions such that the prepolymer prepared has on average more than one isocyanate moiety (group) per molecule. The isocyanate functional prepolymer is present in the curable composition in a sufficient amount to form a cured component when exposed to curing conditions. In a one-part system the isocyanate functional prepolymer containing composition may further comprise, a catalyst and other components as described hereinafter. The one component adhesive systems cure by moisture curing and once formulated are packaged in air and moisture proof containers to prevent curing before application. In adhesive compositions, the adhesive is capable of bonding substrates together such that the substrates remain bound together when exposed to temperatures of about −30° C. to about 100° C. for long periods of time, such as 10 years; and up to temperatures of about 180° C. for short periods, up to 30 minutes.

In a two-part curable system, the two parts are reactive with one another and when contacted undergo a curing reaction. One part of the composition comprises, or contains, one or more of isocyanate functional components, such as prepolymers, wherein one or more of the prepolymers may contain isocyanate functional groups. This is referred to as the resin side or A side. The other component of the composition comprises, or contains, one or more compounds, oligomers or prepolymers having on average more than one group reactive with isocyanate moieties as described herein. The second part is known as the curative or B side. Compounds having on average one or more isocyanate reactive groups can be prepolymers, small chain compounds such as difunctional chain extenders or polyfunctional crosslinking agents, or mixtures thereof. A catalyst may be utilized in the curative side. The reaction product is a cured product which is capable of performing the desired function.

The one or more isocyanate functional components, prepolymers, are present in sufficient quantity to provide cohesive strength, and in adhesive uses, adhesive character to the cured compositions. Such isocyanate functional components, prepolymers, have an average isocyanate functionality sufficient to allow the preparation of a crosslinked polyurethane upon cure and not so high that the isocyanate functional components are unstable. The isocyanate functional components, prepolymers, prefer-ably have a free isocyanate content which facilitates acceptable strength in the compositions prepared, preferably after 30 minutes. For one-part moisture curable systems, the free isocyanate content may be about 0.05 percent by weight or greater based on the weight of the isocyanate functional prepolymer, about 0.5 percent by weight or greater, or about 0.8 percent by weight or greater. In one part compositions, the free isocyanate content may be about 10.0 percent by weight or less, about 5.0 or less, or about 3.0 percent by weight or less. The isocyanate functional prepolymers may, exhibit a poly-dispersity of about 2.5 or less, about 2.3 or less or about 2.1 or less. For two-part isocyanate based adhesive systems, the isocyanate content in the isocyanate functional prepolymers may be about 6 percent by weight or greater, about 8 percent by weight or greater or about 10 percent by weight or greater. For two-part isocyanate based adhesive systems, the isocyanate content in the isocyanate functional prepolymers may be about 35 percent by weight or less, about 30 percent by weight or less or about 25 percent by weight or less.

The viscosity of the isocyanate functional prepolymers may be about 200 Pa·s or less, about 150 Pa·s or less, or about 120 Pa·s or less. The viscosity of the iso-cyanate functional prepolymers may be about 50 Pa·s or greater. The viscosity of the compositions can be adjusted with fillers. Below about 50 Pa·s a composition prepared from the isocyanate functional polymers may exhibit poor high speed tensile strength. Above about 150 Pa·s the isocyanate functional components, prepolymer, may be unstable and hard to pump. “Viscosity” as used herein is measured by the Brookfield Viscometer, Model DV-E with a RV spindle #5 at a speed of 5 revolutions per second and at a temperature of 23° C.

The polyisocyanates useful as isocyanate functional components and in preparing the isocyanate functional prepolymers may include any aliphatic, cycloaliphatic, araliphatic, heterocyclic or aromatic polyisocyanate, or mixtures thereof. The polyisocyanates may comprise aromatic polyisocyanates. The polyisocyanates used may have an average isocyanate functionality of about 2.0 or greater and an equivalent weight of about 80 or greater. The isocyanate functionality of the polyisocyanate may be about 2.0 or greater, about 2.2 or greater, or about 2.4 or greater; and may be about 4.0 or less, about 3.5 or less, or about 3.0 or less. Higher functionality may also be used, but may cause excessive cross-linking, result in a composition which is too viscous to handle and apply easily, and can cause the cured composition to be brittle. The equivalent weight of the polyisocyanate may be about 80 or greater, about 110 or greater, or about 120 or greater; and may be about 300 or less, about 250 or less, or about 200 or less. Exemplary polyisocyanates include those disclosed by Wu, U.S. Pat. No. 6,512,033 at column 3, line 3 to line 49, incorporated herein by reference in their entirety for all purposes. Exemplary isocyanates are aromatic isocyanates, alicyclic isocyanates and derivatives thereof. The aromatic isocyanates may have the isocyanate groups bonded directly to aromatic rings. Specific exemplary polyisocyanates include diphenylmethane diisocyanate and polymeric derivatives thereof, isophorone diisocyanate, tetramethylxylene diisocyanate, 1,6-hexamethylene diisocyanate and polymeric derivatives thereof, bis(4-isocyanatocylohexyl)methane, and trimethyl hexamethylene diisocyanate. The isocyanate may be diphenylmethane diisocyanate. Exemplary aromatic polyisocyanates include diphenylmethane diisocyanate and polymeric derivatives thereof. The amount of isocyanate containing compound used to prepare the isocyanate functional prepolymers is that amount that gives the desired properties, such as free isocyanate content and viscosities. The isocyanates may be used to prepare the isocyanate prepolymers in an amount of about 1.3 equivalents of isocyanate (NCO) per equivalent of active hydrogen or greater, about 1.4 equivalents or greater or about 1.5 equivalents or greater. The amount of polyisocyanates used to prepare the isocyanate functional prepolymers may be about 2.0 equivalents of isocyanate per equivalent of active hydrogen or less, about 1.8 equivalents or less or about 1.6 equivalents less.

The isocyanate functional prepolymers may be the reaction product of one or more polyisocyanates and one or more isocyanate reactive compounds wherein an excess of polyisocyanate is present on an equivalents basis. The isocyanate reactive compounds may be one or more polyols, and include those disclosed in Wu, U.S. Pat. No. 6,512,033 at column 4, line 10 to line 64, incorporated herein by reference in their entirety for all purposes, for example, polyether polyols, polyester polyols, poly(alkylene carbonate) polyols, hydroxyl containing polythioethers and mixtures thereof. The polyols may be polyether polyols containing one or more alkylene oxide units in the backbone of the polyol. The alkylene oxide units may be ethylene oxide, propylene oxide, butylene oxide or mixtures thereof and may contain straight or branched chain alkylene units. The polyol may contain propylene oxide units, ethylene oxide units or mixtures thereof. Mixtures of alkylene oxide may be arranged randomly or in blocks. The polyol may comprise propylene oxide chains with ethylene oxide chains capping the polyol. The polyols may comprise a mixture of diols and triols. Ethylene oxide capped polypropylene oxides may be hydrophobic, and may contain less than about 20 mole percent of ethylene oxide or less than 10 mole percent of ethylene oxide in the backbone. The isocyanate-reactive prepolymer may have a functionality of about 1.8 or greater, about 1.9 or greater, or about 1.95 or greater; and may be about 4.0 or less, about 3.5 or less, or about 3.0 or less. The equivalent weight of the isocyanate-reactive compound may be about 200 or greater, about 500 or greater, or about 1,000 or greater; and may be about 5,000 or less, about 3,000 or less, or about 2,500 or less.

The compositions may further comprise one or more prepolymers containing one or more polyether polyols having dispersed therein or grafted to the backbone one or more organic based polymer particles. The one or more organic based polymer particles may be based on monovinylidene aromatic monomers and copolymers of mono-vinylidene aromatic monomers with conjugated dienes, acrylates, methacrylates, unsaturated nitrites or mixtures thereof. The copolymers can be block or random copolymers. The one or more organic based polymer particles may comprise copolymers of unsaturated nitrites, conjugated dienes and a monovinylidene aromatic monomer, a co-polymer of an unsaturated nitrile and a monovinyl-idene aromatic monomer or a poly-urea. The particles may comprise a polyurea or polystyrene-acrylonitrile copolymer such as poly-styrene-acrylonitrile copolymers. The particle size of the one or more organic based polymer particles may be about 10 microns or greater or about 20 microns or greater. The particle size may be about 50 microns or less or about 40 microns or less. The polyol having organic polymer particles dispersed therein or grafted thereto contain a sufficient amount of the particles such that the adhesive upon cure has sufficient hard-ness for the desired use and not so much such that the cured adhesive has too much elasticity as defined by elongation. The polyols contain about 20 percent by weight or greater of organic polymer particles based on the weight of the polyols, about 30 percent by weight or greater or about 35 percent by weight or greater. The polyols contain about 60 percent by weight or less of the particles based on the weight or the particles, about 50 percent by weight or less or about 45 percent by weight or less. The organic based polymer particles are included in the prepolymer by inclusion of a polyol containing them, for example a triol, having dispersed therein particles of an organic based polymer, for example one or more of thermoplastic polymers, rubber-modified thermoplastic polymers or a polyureas dispersed in one or more triols. Polyols having organic polymer particles dispersed therein or grafted thereto are disclosed in Zhou, U.S. Pat. No. 6,709,539 at column 4, line 13 to column 6, line 18, incorporated herein by reference in their entirety for all purposes. The polyols used to disperse the organic particles may be one or more polyether triols. Prepolymers containing one or more organic based polymers particles may be present in compositions of the invention in a sufficient amount to enhance the elastomeric nature and the modulus of the compositions. Such prepolymers may be contained in the composition in an amount below about 5 percent by weight and greater than 0 if present or about 0.1 percent by weight or greater.

The isocyanate reactive compounds are present in an amount sufficient to react with most of the isocyanate groups of the isocyanates leaving enough isocyanate groups to correspond with the desired isocyanate content of the prepolymer. The compounds containing isocyanate reactive groups may be present in an amount of about 50 percent by weight or greater based on the prepolymer, about 65 percent by weight or greater or about 80 percent by weight or greater. The compounds containing isocyanate reactive groups may be present in an amount of about 90 percent by weight or less based on the prepolymer or about 85 percent by weight or less.

The isocyanate functional prepolymers used may include isocyanate functional prepolymers containing isocyanate moieties and alkoxysilane moieties. All of isocyanate functional prepolymers may contain alkoxysilane moieties or such isocyanate functional prepolymers may be blended with isocyanate functional preoplymers which do not contain alkoxysilane moieties. The isocyanate functional prepolymers may contain sufficient alkoxysilane moieties to improve the adhesion to substrates, for instance glass and coated substrates. The alkoxysilane content in the isocyanate functional prepolymers may be about 0.2 percent by weight or greater, about 0.4 percent by weight or greater or about 0.8 percent by weight or greater. The alkoxysilane content in the isocyanate functional prepolymers may be about 6.0 percent by weight or less, about 5.0 percent by weight or less or about 4 percent by weight or less. Alkoxysilane content means the weight percentage of alkoxysilane moieties to the total weight of the prepolymer. Silanes having groups reactive with isocyanate moieties, can be reacted with the terminal isocyanate moieties of isocyanate functional prepolymers. Such reaction products are disclosed in U.S. Pat. Nos. 4,374,237 and 4,345,053 relevant parts incorporated herein by reference. Silanes having isocyanate reactive moieties reactive with isocyanate moieties may be reacted into the backbone of the prepolymer by reacting such silane with the starting materials during the preparation of the prepolymer as disclosed in U.S. Pat. No. 4,625,012, relevant portions incorporated herein by reference.

The isocyanate functional prepolymers may be prepared by any suitable method, such as bulk polymerization and solution polymerization. The reaction to prepare the prepolymers is carried out under anhydrous conditions, preferably under an inert atmosphere such as a nitrogen blanket, and to prevent crosslinking of the isocyanate groups by atmospheric moisture. The reaction may be carried out at a temperature from about 0° C. to about 150° C., or from about 25° C. to about 90° C., until the residual isocyanate content determined by titration of a sample is very close to the desired value. The reactions to prepare the prepolymer may be carried out in the presence of urethane catalysts, for example: stannous salts of carboxylic acids, such as stannous octoate, stannous oleate, stannous acetate, and stannous laurate; dialkyltin dicarboxylates, such as dibutyltin dilaurate and dibutyltin diacetate; tertiary amines; and tin mercaptides. The catalyst may be stannous octoate. The amount of catalyst employed may be from about 0.005 to about 5 parts by weight of the mixture catalyzed. The reaction may be carried out in admixture with a plasticizer.

The one or more isocyanate functional prepolymers are present in the composition in a sufficient amount such that the cured composition has sufficient strength for its designed purpose, in the case of adhesive systems such that the adhesive is capable of bonding substrates together and to provide the desired cohesive and adhesive strengths. The prepolymers may be present in an amount of about 20 percent by weight or greater based on the weight of the composition, about 30 percent by weight or greater or about 50 percent by weight or greater. The prepolymers may be present in an amount of about 70 percent by weight or less based on the weight of the composition, about 60 percent by weight or less or about 55 percent by weight or less. Wherein the prepolymers comprise one or more isocyanate functional prepolymers and one or more of prepolymers containing isocyanate functional groups and alkoxysilane groups, the one or more prepolymers containing isocyanate functional groups and alkoxysilane groups are present in an amount of about 1 percent by weight or greater based on the weight of the composition, about 5 percent by weight or greater or about 10 percent by weight or greater. The one or more of prepolymers containing isocyanate functional groups and alkoxysilane groups may be present in an amount of less than 70 percent by weight, 50 percent by weight or less or about 20 percent by weight or less. In these embodiments the remainder of the prepolymer is one or more isocyanate functional prepolymers that do not contain alkoxysilane groups.

The compositions disclosed contain one or more quaternary ammonium modified nanoclays. The one or more one or more quaternary ammonium modified nanoclays are present to modify the rheology of the compositions disclosed so as to provide a sag resistant composition that has the capability of fixturing a first substrate to second substrate upon application and contacting of the substrates with the composition. The one or more one or more quaternary ammonium modified nanoclays may also enhance the strength buildup of the composition such that where the composition is utilized to bond windows into vehicles the vehicles may be driven about 30 minutes after application. The one or more quaternary ammonium modified nanoclays contain at least one particulate nanoclay capable of functioning as a thixotropic agent, wherein the nano-clay particles have at least one dimension that is less than 100 nm, about 50 nm or less or about 10 nm or less. The nanoclay may be in the form of platelets having a thickness of about 20 nm or less, about 10 nm or less, or about 5 nm or less and a diameter that is many times larger than the thickness of the platelets. The aspect ratio (the ratio of diameter to thickness) may be within the range of about 50:1 to about 1000:1 or even greater. The surface area of nanoclays may be relatively high, and may be about 100 mm²/g or greater or about 500 mm²/g or greater. Nanoclays also have relatively high surface:volume ratios, thereby distinguishing them from conventional fillers of the type long used in resin and plastic formulations. When initially added to the compositions, the nanoclay platelets or particles may be layered or stacked upon each other and undergo separation or exfoliation when dispersed within the composition. Alternatively, the nano-clay may be rod-like in form, wherein the individual rods are relatively small in diameter, about 20 nm or less, about 10 nm or less, or about 5 nm or less, with a length that is many times greater than the diameter. The nanoclay rods may have an aspect ratio (length:diameter) within the range of about 50 to about 1000 or even greater.

The quaternary ammonium modified nanoclay may be prepared from a mineral clay mixture that has been treated with one or more alkyl quaternary ammonium compounds. The nanoclays may be prepared from a mixture of clays, wherein one clay type is sepiolite, palygorskite, or a mixture thereof and a second clay type may be a smectite clay. Smectite clays include hectorite, monmorillonite, bentonite, beidelite, saponite, and stevensite. The first clay type may be the predominant type of clay from which the organoclay is prepared, for example the first clay may comprise 50 to 95 weight percent of the clay mixture with the balance being smectite. Exemplary nanosized organically modified clays prepared from clay mixtures are described in U.S. Pat. Nos. 6,036,765; 6,534,570; and 6,635,108, each of which are incorporated herein by reference in their entirety for all purposes.

Exemplary procedures for preparing the quaternary ammonium modified nanoclays, the mineral, such as sepiolite and/or palygorskite, is crushed, ground, slurried in water and screened to remove grit and other impurities. The smectite mineral is subjected to a similar regimen. Each of the component minerals is then subjected, while in the form of a dilute (1 to 6 percent solids) aqueous slurry, to high shearing in a suitable mill. In the shearing step a homogenizing mill of the type wherein high speed fluid shearing of the slurry is effected by passing the slurry at high velocities through a narrow gap, across which a high pressure differential is maintained, may be used. This can be effected in a Manton-Gaulin (“MG”) mill, which is sometimes referred to as a “Gaulin homogenizer”, which is described in U.S. Pat. Nos. 4,664,842 and 5,110,501, each of which is incorporated herein by reference in its entirety. The conditions under which the MG mill may be used is disclosed in the aforementioned patents; for example, the pressure differential across the gap is may be in the range of from 70,300 to 562,400 g/cm², with 140,600 to 351,550 g/cm² being more typical. The slurry to be treated may be passed one or more times through the MG mill. The rotor and stator arrangement described U.S. Pat. No. 5,160,454 may also be utilized to effect high shearing of the clay. The use of high shear is believed to act to “debundle” the otherwise “bundled” type of structures which exist in some of the minerals.

Following the high shear step, the clay component slurries may be mixed with one another. Alternatively, the two or more clay components can be intermixed in a single slurry before the latter is subjected to the high shear step. Following such step the single slurry is intermixed with the alkyl quaternary ammonium salt(s), after which the slurry is dewatered and the alkyl quaternary ammonium-treated clay dried and ground to provide a dry organically modified mixed mineral thixotrope. Additional methods of preparing organically modified clays are described, for example, in U.S. Pat. Nos. 6,787,592; 5,728,764; 5,663,111; 5,739,087; 5,728,764; 5,663,111; 5,429,999; 5,336,647; 5,160,454; 5,075,033; 4,894,182; 4,742,098; 4,695,402; 4,664,842; 4,569,923; 4,517,112; 4,474,706; 4,474,705; 4,434,076; 4,412,018; 4,382,868; 4,116,866 and 2,966,506, each of which is incorporated herein by reference in its entirety. Exemplary nanosized organically modified clays available from commercial sources that are useful in the present invention include GARAMITE 1958 (described by the supplier Southern Clay Products as a mixed mineral thixotrope containing about 20 weight percent montmorillonite and 80 weight percent smectite).

The one or more quaternary ammonium modified nanoclays may be utilized in a sufficient amount to modify the rheology of the compositions disclosed so as to provide a sag resistant composition that has the capability of fixturing a first substrate to second substrate upon application and contacting of the substrates with the composition and to enhance the strength buildup of the composition such that where the composition is utilized to bond windows into vehicles the vehicles can be driven normally 30 minutes after application. The one or more quaternary ammonium modified nanoclays may be present in an amount of about 0.5 percent by weight or greater based on the weight of the composition, about 1.0 percent by weight or greater, or about 1.5 percent by weight or greater. The one or more quaternary ammonium modified nanoclays may be present in an amount of about 4.0 percent by weight or less based on the weight of the composition, about 3.0 percent by weight or less, or about 2.5 percent by weight or less.

The composition may comprise components to control the rheology, viscosity, pumpability and the sag characteristics of the composition, such as one or more fillers or thixotropes. Thixotropes are additives that provide a shear thinning rheology with a delayed recovery in viscosity as the shear is relaxed. These materials are added in a sufficient amount such that the composition exhibits the desired rheology, viscosity and the sag characteristics. Any rheology control component that provides acceptable rheology for the desired use may be utilized, for example coated and uncoated calcium carbonate, fumed silica, organically modified fumed silicas, polyvinylchloride powder (which may be swollen in hydrocarbon solvents, such as aromatic hydrocarbons), poly-ureas, polyamide waxes, castor oil derivatives, organoclays, and the like. The thixo-tropes are added in a sufficient amount to control the flow of the material during and after application, the amount of control varies by application, for example an amount capable of maintaining the shape of an extruded shape, such as a triangular bead (25 mm tall, 10 mm wide), without movement on vertical surface after application, while maintaining a low enough viscosity to be applied. The rheology control additives may be present in an amount of about 0.5 or greater based on the weight of the compositions, about 0.5 by weight or greater or about 1.0 by weight or greater. The rheology control additives may be present in an amount of about 3.0 percent by weight or less based on the weight of the composition, about 2.5 percent by weight or less, or about 2 percent by weight or less.

One-part polyisocyanate functional compositions and either or both of the resin part and the curative part for two-part isocyanate functional systems may contain plasticizers, fillers, pigments, stabilizers and other additives commonly present in curable polyurethane compositions. By the addition of such materials, physical properties such as rheology, flow rates and the like can be modified. To prevent premature hydrolysis of the moisture sensitive groups of the isocyanate functional component, fillers should be thoroughly dried before admixture therewith.

The compositions may contain plasticizers, such as those commonly used in polyurethane compositions, present in an amount sufficient to disperse the isocyanate functional prepolymers in the final compositions. The plasticizers can be added to the composition either during preparation of the prepolymers or during compounding of the composition. Exemplary plasticizers include straight and branched alkyl-phthalates, such as diisononyl phthalate, dioctyl phthalate and dibutyl phthalate, a partially hydrogenated terpenes, trioctyl phosphate, alkylsulfonic acid esters of phenol (Mesamoll, Bayer), toluene-sulfamide, adipic acid esters, castor oil, xylene, 1-methyl-2-pyrrolidinone and toluene. The plasticizers may branched, such as branched chain alkyl phthalates (diisononyl phthalates (available as PLATINOL N from BASF)). The amount of plasticizer used is that amount sufficient to give the desired rheological properties and disperse the components in the composition. The plasticizer may be present in about 1 percent by weight or greater of the composition, about 5 percent by weight or greater or about 10 percent by weight or greater. The plasticizer may be present in about 50 percent by weight or less of the composition or about 40 percent by weight or less.

One or more types of fillers may be utilized in the composition for a variety of reasons such as to reinforce the composition, adjust viscosity and rheology, render the composition hand-gun applicable and strike a balance between cost and the desired properties of the composition and parts thereof. Exemplary classes of fillers include reinforcing fillers, clays, non-pigmented fillers, thixotropes and combinations thereof.

Fillers that impart a balance of cost and viscosity to each part and comprise clays and non-pigmented fillers may be present. Such fillers are used in a sufficient amount to impart an acceptable balance of viscosity and cost to the formulation and to achieve the desired properties of the composition. Among fillers useful for this purpose are clays, untreated and treated talc, and calcium carbonates. Exemplary clays useful in the invention include kaolin, surface treated kaolin, calcined kaolin, aluminum silicates and surface treated anhydrous aluminum silicates. Kaolin is also known as Kaolinite and comprises compounds represented by the chemical formula Al₂Si₂O₅ (OH)₄, and it most often occurs as clay-sized, platelike, hexagonally shaped crystals. Clays can be used in any form which facilitates formulation of a composition having the desired properties, for example a composition that can be utilized as a hand-dispensable adhesive. Clays may be admixed in the form of pulverized powder, spray-dried beads or finely ground particles. Clays or non-pigmented fillers may be present in an amount sufficient to render the rheology of the composition suitable to function as desired, such as an adhesive applicable by hand-gun. Clays or non-pigmented fillers may be used in an amount of about 0 percent by weight or greater of the composition, about 3 percent by weight or greater, about 5 percent by weight or greater, about 10 percent by weight or greater or about 16 percent by weight or greater. Clays or non-pigmented fillers may be used in an amount of about 60 percent by weight or less of the composition, about 50 percent by weight or less, about 30 percent by weight or less or about 23 percent by weight or less.

The composition may comprise a reinforcing filler present to improve the strength and rheology of the composition, which may comprise one or more forms of carbon black. Reinforcing fillers may be present in a sufficient amount to reinforce the composition and to improve the rheology of the composition. Reinforcing fillers may be present in an amount such that the parts of the composition are nonconductive. Nonconductivity is generally understood to mean a volume resistivity of the composition of at least 10¹⁰ Ohm-cm. When carbon black is used as the reinforcing filler, the carbon black used may be a standard carbon black. Standard carbon black is carbon black which is not specifically surface treated or oxidized to render it nonconductive. One or more nonconductive carbon blacks may be used in conjunction with the standard carbon black. The amount of standard carbon black in the composition may be that amount which provides the desired color, viscosity, sag resistance and strength and is below the percolation threshold of the carbon black in the composition. The percolation threshold is the concentration at which the composition becomes conductive. If nonconductivity of the composition is desired, standard carbon black may be utilized at a level at which the composition is nonconductive. The non-conductive carbon blacks may be high surface area carbon blacks, which exhibit an oil absorption of about 110 cc/100 g or greater, about 115 cc/100 g or greater and/or an iodine number of about 130 mg/g or greater or about 150 mg/g or greater. Exemplary non-conductive carbon blacks include ELFTEX™ 57100, MONARCH RAVEN™ 1040 and RAVEN™ 1060 carbon blacks. Standard carbon blacks include RAVEN™ 790, 450, 500, 430, 420 and 410 carbon blacks available from Colombian and CSX™ carbon blacks available from Cabot, and PRINTEX™30 carbon black available from Degussa. Reinforcing fillers may be present based on the weight of the composition, in an amount of about 0 percent by weight or greater, about 10 percent by weight or greater or about 14 percent by weight or greater. Reinforcing fillers may be present based on the weight of the composition, in an amount of about 20 percent by weight or less, about 18 percent by weight or less, or about 16 percent by weight or less. If a non-conductive composition is desired the concentration of conductive carbon black may be below about 18 percent by weight in the composition or below about 16 percent by weight.

The composition may further comprise a polyfunctional isocyanate for the purpose of improving the modulus of the composition in the cured form. The polyisocyanates can be any monomeric, oligomeric or polymeric isocyanates having a nominal functionality of about 3 or greater or about 3.2 or greater. The polyfunctional isocyanates may have a nominal functionality of about 5 or less, about 4.5 or less or about 4.2 or less. The polyfunctional isocyanates can be any isocyanates which are reactive with the isocyanate functional component and which improve the modulus of the cured composition. The polyisocyanates can be monomeric; trimeric isocyanurates or biurets of monomeric isocyanates; oligomeric or polymeric, the reaction product of several units of one or more monomeric isocyanates. Examples of preferred polyfunctional isocyanates include trimers of hexamethylene diisocyanate, such as those available from Bayer under the trademark and designation DESMODUR N3300, DESMODUR N3400 DESMODUR N-100, and polymeric isocyanates such as polymeric MDI (methylene diphenyl diiso-cyanates) such as those marketed by The Dow Chemical Company under the trademark of PAPI, including PAPI 20 and PAPI 27 polymeric isocyanates. The polyfunctional isocyanates are present in a sufficient amount to impact the modulus of the cured compositions. If too much is used, the cure rate of the composition is unacceptably slowed down. If too little is used, the desired modulus levels may not be achieved. The polyfunctional isocyanate may be present in an amount of about 0.5 percent by weight or greater based on the weight of the composition, about 1.0 percent by weight or greater or about 1.4 percent by weight or greater. The polyfunctional isocyanate may be present in an amount of about 8 percent by weight or less, based on the weight of the composition, about 5 percent by weight or less or about 3 percent by weight or less.

The compositions also contain one or more catalysts known to the skilled artisan which catalyze the reaction of isocyanate moieties with water or an isocyanate reactive moiety containing compound. Exemplary catalysts are organotin compounds, metal alkanoates, tertiary amines, or mixtures thereof. A mixture of a tertiary amine and a metal alkanoate or organotin compounds may be used. A mixture of tertiary amines, such as dimorpholino diethyl ether, and organotin compounds, such as dibutyl tin dilaurate may be used. Exemplary organotin compounds include alkyl tin oxides, stannous alkanoates, dialkyl tin carboxylates and tin mercaptides. Stannous alkanoates include stannous octoate. Alkyl tin oxides include dialkyl tin oxides, such as dibutyl tin oxide and its derivatives. The organotin catalyst may be a dialkyltin dicarboxylate or a dialkyltin dimercaptide. Exemplary dialkyl dicarboxylates include 1,1-dimethyltin di-laurate, 1,1-dibutyltin diacetate and 1,1-dimethyl dimaleate. Exemplary metal alkanoates include bismuth octoate or bismuth neodecanoate. The organotin compound or metal alkanoate may be present in an amount of about 60 parts per million or greater based on the weight of the composition or about 120 parts by million or greater. The organo tin compound or metal alkanoate may be present in an amount of about 1.0 percent or less based on the weight of the composition, about 0.5 percent by weight or less or about 0.1 percent by weight or less.

Exemplary tertiary amine catalysts include dimorpholinodialkyl ether, a di((dialkylmorpholino)alkyl)ether, bis-(2-dimethylaminoethyl)ether, triethylene diamine, penta-methyldiethylene triamine, N,N-dimethylcyclohexylamine, N,N-dimethyl piperazine 4-methoxy-ethyl morpholine, N-methylmorpholine, N-ethyl morpholine, diazabicyclo compounds and mixtures thereof. An exemplary dimorpholinodialkyl ether is dimorpholinodiethyl ether. An exemplary di-((dialkylmorpholino)alkyl)ether is (di-(2-(3,5-dimethyl morpholino)ethyl)-ether). Diazabicyclo compounds are compounds which have diazo-bicyclo structures. Exemplary diazabicyclo hydrocarbons include diazabicycloalkanes, diazabicyclo alkene salts and mixtures thereof. Exemplary diazabicycloalkanes include diazabicyclooctane, available from Air Products under the trademark and designations, DABCO WT, DC 1, DC 2 and DC 21. Exemplary diazabicycloalkene salts include diazabicycloundecene in the phenolate, ethylhexoate, oleate and formate salt forms, available from Air Products under the trademark and designations, POLYCAT SA 1, SA 1/10, SA 102 and SA 610. One or more diazabicyclo compounds and one or more organometallic and/or other tertiary amine catalysts may be present in the composition. Tertiary amines may be employed in an amount, based on the weight of the composition, of about 0.01 percent by weight or greater, about 0.05 percent by weight or greater, about 0.1 percent by weight or greater or about 0.2 percent by weight or greater and about 2.0 percent by weight or less, about 1.75 percent by weight or less, about 1.0 percent by weight or less or about 0.4 percent by weight or less.

The composition may further comprise stabilizers, which function to protect the composition from moisture, thereby inhibiting advancement and preventing pre-mature cross-linking of the isocyanates or silanol groups in the curable composition, such stabilizers include diethylmalonate, alkylphenol alkylates, paratoluene sulfonic isocyanates, benzoyl chloride, calcium oxide and orthoalkyl formates. Such stabilizers may be used in an amount of about 0.1 percent by weight or greater based on the weight of the curable composition, about 0.5 percent by weight or greater or about 0.8 percent by weight or greater. Such stabilizers may be used in an amount of about 5.0 percent by weight or less based on the weight of the curable composition, about 2.0 percent by weight or less or about 1.4 percent by weight or less.

The composition may further comprise an adhesion promoter, such as those disclosed in Mandi, U.S. Patent Publication 2002/0100550 paragraphs 0055 to 0065 and Hsieh, U.S. Pat. No. 6,015,475 column 5, line 27 to column 6, line 41 incorporated herein by reference in their entirety for all purposes. Exemplary classes of adhesion promoters include silanes, titanates and zirconates and the like. The adhesion promoter may be a silane in some form. Methods of including silane functionality in the adhesive formulations are disclosed in Wu et al., U.S. Pat. No. 6,512,033 at column 5, line 38 to column 7, line 27; U.S. Pat. Nos. 5,623,044; 4,374,237; 4,345,053 and 4,625,012, relevant portions incorporated herein by reference in their entirety for all purposes. The silane may be blended with the composition, a silane, having active hydrogen moieties, can be reacted with a polyisocyanate to form an adduct which is blended with the composition, reacted with a polyurethane prepolymer or reacted with a polyisocyanate and a compound having on average more than one moiety reactive with an isocyanate moiety to form a prepolymer with both isocyanate and silane moieties (alkoxysilane groups). The adduct may be a reaction product of a secondary amino- or mercaptoalkoxy silane and a polyisocyanate, the adduct having an average of at least one silane group and at least one isocyanate group per molecule (hereinafter “adduct”). The silane may be a mercaptosilane or an amino-silane, or may be a mercaptotrialkoxy-silane or an amino-trialkoxy silane, for example: N,N-bis[(3-triethoxysilyl) propyl]amine; N,N-bis [(3-tripropoxysilyl) propyl] amine; N-(3-tri-methoxysilyl) propyl-3-[N-(3-trimethoxysilyl)-propyl amino] propionamide; N-(3-triethoxy-silyl)propyl-3-[N-3-tri-ethoxysilyl)-propylamino]-propionamide; N-(3-trimethoxysilyl)propyl-3-[N-3-triethoxysilyl) propylamino]propionamide; 3-trimethoxysilylpropyl 3-[N-(3-tri-methoxysilyl)-propyl amino]-2-methylpropionate; 3-triethoxysilylpropyl3-[N-(3-triethoxy-silyl)-propylamino]-2-methyl propionate; 3-trimethoxysilylpropyl3-[N-(3-triethoxysilyl)-propylamino]-2-methyl propionate; and the like. The organo functional silane may be gamma-mercaptopropyl-trimethoxysilane (available as A189 from Union Carbide) or N,N′-bis((3-trimethoxy silyl) propyl) amine. The amount of adhesion promoter present is that amount which enhances the adhesion of the composition to the substrate surface. The amount of adhesion promoter present may be about 0.01 percent by weight or greater based on the weight of the composition or about 0.1 percent by weight or greater. The amount of adhesion promoter may be about 10 percent by weight or less, about 2.5 percent by weight or less or about 2.0 percent by weight or less. The adhesion promoter can be located in either or both parts of a two part composition.

The composition may comprise a hydrophilic material that functions to draw atmospheric moisture into the composition, to enhance the cure speed of the formulation. The hydrophilic material may be a liquid, including pyrrolidones such as 1 methyl-2-pyrrolidone (or N-methyl pyrrolidone). The hydrophilic material may be present in an amount of about 0.1 percent by weight or greater or about 0.3 percent by weight or greater and about 1.0 percent by weight or less or about 0.6 percent by weight or less.

Two part compositions may comprise a curing agent located in the second part, which is a compound that contains greater than one isocyanate reactive functional group, preferably hydroxyl or amine functional groups. The curing agents may be one or more chain extenders, crosslinking agents, polyols or polyamines. Polyols as described hereinbefore can be utilized as curing agents. One class of polyols or polyamines can be prepolymers as described hereinbefore prepared utilizing excess equivalents of active hydrogen functional groups such that the resulting prepolymers contain active hydrogen functional groups, preferably hydroxyl and or amino groups. The curing agent may comprise one or more low molecular weight compounds having two or more isocyanate reactive groups and a hydrocarbon backbone wherein the backbone may further comprise one or more heteroatoms. It is advantageous to use low molecular weight compounds in two-part compositions which may be compounds known in the art as chain extenders, difunctional compounds, or crosslinkers, having, on average, greater than two active hydrogen groups per compound. The molecular weight of the low molecular weight compound may be about 250 or less, about 120 or less or about 100 or less. The low molecular weight compound is used in a sufficient amount to obtain the desired G-Modulus (E-Modulus). The low molecular compound may be located in the resin side, the curative side or both. The low molecular weight compound may be present in composition in an amount of about 2 percent by weight or greater, about 2.5 percent by weight or greater or about 3.0 percent by weight or greater. The low molecular weight compound may be present in the composition in an amount of about 10 percent by weight or less, about 8 percent by weight or less or about 6 percent by weight or less.

In a two-part composition, the curative part may further comprise polyoxyalkylene polyamine having 2 or greater amines per polyamine, 2 to 4 amines per polyamine or 2 to 3 amines per polyamine. The polyoxyalkylene polyamine may have a weight average molecular weight of about 200 or greater or about 400 or greater. The polyoxyalkylene polyamine has a weight average molecular weight of about 5,000 or less or about 3,000 or less. Exemplary polyoxyalkylene polyamines are JEFFAMINE™ D-T-403 polypropylene oxide triamine having a molecular weight of about 400 and JEFFAMINE™ D-400 polypropylene oxide diamine having a molecular weight of about 400. The polyoxyalkylene polyamines are present in a sufficient amount to prevent the composition from sagging once mixed and applied. The polyoxyalkylene polyamine may be present in the curable composition in an amount of about 0.2 percent by weight or greater, about 0.3 percent by weight or greater or about 0.5 percent by weight or greater. The polyoxyalkylene polyamine may be present in the curable composition in an amount of about 6 percent by weight or less, about 4 percent by weight or less or about 2 percent by weight or less.

The curing agent may comprise one or more polyols. Any polyol having groups reactive with isocyanate moieties, including those disclosed herein may be utilized as curing agents. Polyols useful as curing agents include polyols having dispersed therein or grafted to their backbones organic particles as described herein, including polyols having styrene acrylonitrile (SAN) particles dispersed therein or grafted to the backbone. Curing agents are used in a sufficient amount such that the two part compositions cure to provide the desired properties as described herein. The curing agents, recited compounds or mixtures of recited compounds useful as curing agents including polyols, may be present in an amount of about 10 percent by weight or greater of the second part, about 20 percent by weight or greater or about 30 percent by weight or greater. The curing agents may be present in an amount of about 60 percent by weight or less of the second part, about 50 percent by weight or less or about 40 percent by weight or less.

The compositions may also contain other durability stabilizers known in the art, including alkyl substituted phenols, phosphites, sebacates and cinnamates, for example organophosphites. Durability stabilizers may be present in a sufficient amount to enhance durability of bond of the adhesive composition to a substrate surface. Exemplary phosphites are disclosed in Hsieh et al. U.S. Pat. No. 7,416,599 column 10, line 47 to Column 11 line 25, incorporated herein by reference. Durability stabilizers may be present in an amount of about 0.1 percent by weight or greater or about 0.2 percent by weight or greater based on the weight of the composition. Durability stabilizers may be present in an amount of about 1.0 percent by weight or less or about 0.5 percent by weight or less based on the weight of the composition.

The compositions may further include a light stabilizer, which facilitates the system maintaining durable bond to the substrate for a significant portion of the life of the structure to which it is bonded. Exemplary light stabilizers are hindered amine light stabilizers, such as disclosed in Hsieh et al. U.S. Pat. No. 7,416,599 column 11, line 31 to line 63, incorporated herein by reference. Exemplary hindered light amine stabilizers include Tinuvin 1,2,3 bis-(1-octyloxy-2,2,6,6, tetramethyl-4-piperidinyl)sebacate and Tinuvin 765, bis(1,2,2,6,6,-pentamethyl-4-piperidinyl) sebacate. A sufficient amount of light stabilizer to enhance bond durability to the substrate may be used. Light stabilizers may be used in amount of about 0.1 percent by weight or greater based on the composition weight, about 0.2 percent by weight or greater or about 0.3 percent by weight. Light stabilizers may be used in an amount of about 3 weight percent or less based on the weight of the composition, about 2 weight percent or less or about 1 weight percent or less.

The composition may further comprise an ultraviolet light absorber which enhances the durability of the bond of the composition to a substrate, for example benzophenones and benzotriazoles and those disclosed in Hsieh et al. U.S. Pat. No. 7,416,599 column 11, line 64 to Column 12 line 29, incorporated herein by reference. Exemplary UV light absorbers include Cyasorb UV-531 2-hydroxy-4-n-octoxybenzophenone and Tinuvin 571 2-(2H-benzotriazol-2-yl)-6-dodecyl-4-methylphenol, branched and linear. The UV light absorber is used in sufficient amount to enhance the durability of the bond of the adhesive to the substrate. The UV absorber may be used in an amount of about 0.1 percent by weight or greater based on the weight of the composition, about 0.2 weight percent or greater or about 0.3 weight percent or greater. The UV light inhibitor may be used in amount of about 3 percent by weight or less based on the weight of the composition, about 2 percent by weight or less or about 1 percent by weight or less.

The composition may be formulated by blending the components together using means well known in the art, such as in a suitable mixer. The blending is preferably conducted in an inert atmosphere, such as nitrogen or argon, in the absence of oxygen and atmospheric moisture to prevent premature reaction. The plasticizers may be added during blending of all the components. The ingredients are blended for a sufficient time to prepare a well-blended mixture, preferably from about 10 to about 60 minutes. Once formulated, it is packaged in a suitable container such that it is protected from atmospheric moisture and oxygen.

The viscosity of the compositions or the components of the composition may be selected to allow the compositions or components to be applied using a hand-mixer. The relevant viscosity is the viscosity of the composition or components at their temperature of application. The press flow viscosity of the composition or components at their application temperature may be about 5 seconds or greater, about 10 seconds or greater or about 15 seconds or greater. The press flow viscosity of the compositions or components at their application temperature may be about 55 seconds or less, about 50 seconds or less, or about 40 seconds or less. Where the composition is a two part composition the two parts may exhibit similar viscosities. The mixed two-part compositions may have a suitable viscosity to allow application without dripping. The viscosities of the two individual components may be of the same order of magnitude. For lower viscosities, the components may require gelling agent known in the art to prevent sag of the uncured adhesive system. Two-part adhesive compositions start to cure upon mixing the two parts. Curing can be accelerated by applying heat to the curing adhesive by means of infrared heat, induction heat, convection heat, microwave heating, application of ultrasonic vibration and the like or by adding moisture.

The compositions may be used to bond a variety of substrates together, such as porous and nonporous substrates. The compositions are applied to a substrate and the composition on the first substrate is thereafter contacted with a second substrate. The surfaces to which the composition may be applied may be cleaned activated and/or primed prior to application of the composition, see for example, U.S. Pat. Nos. 4,525,511; 3,707,521 and 3,779,794, relevant parts are incorporated herein by reference. The compositions are applied at temperature at which they can be pumped. The one part adhesive compositions cure in the presence of atmospheric moisture, which is sufficient to result in curing of the composition. Curing can be accelerated by the addition of additional water or by applying heat to the curing composition by means of convection heat, induction heat, infrared heating, microwave heating and the like. The compositions may be formulated to provide an open time of at least about 3 minutes or greater or about 5 minutes or greater. The compositions may be formulated to provide an open time of about 30 minutes or less or about 15 minutes or less. “Open time” means the time after application of the composition to a first substrate until it starts to become a high viscous paste and is not subject to deformation during assembly to conform to the shape of and adhere to the second substrate.

The compositions may be used to bond glass or abrasion coated transparent plastic to other substrates such as metal or plastics, for example the first substrate is a window and the second substrate is a window frame of an automobile or a building. The window may be cleaned and/or have a wipe or primer applied to the area to which the composition is to be bonded. The window flange may be primed with a paint primer. The composition is applied in a bead to the periphery of the window located such that it will contact the window flange when placed in the vehicle. The window with the composition located thereon is then placed into the flange with the composition located between the window and the flange. The bead of the composition is a continuous bead that functions to seal the junction between the window and the window flange. A continuous bead of the composition is a bead that is located such that the bead connects at each end to form a continuous seal between the window and the flange when contacted. Thereafter the composition is allowed to cure.

In use, the components of two-part compositions are blended. In two-part compositions, the volume ratio at which the two parts are combined is preferably a convenient whole number to facilitate application of the curable composition with conventional, commercially available dispensers including static and dynamic mixing. The blended polymerizable composition is extruded from the mixing chamber onto a substrate. When using electrically-driven equipment, dynamic mixing may be used. Some common mix ratios are 1:1, 2:1, 4:1 and 10:1 and can also be odd ratios, such that about 1:1. Two-part adhesive compositions start to cure upon mixing the two parts. Curing can be accelerated by applying heat to the curing adhesive using induction heat, convection heat, infrared heating, microwave heating and the like.

One part adhesives containing isocyanate functional prepolymers and isocyanate functional prepolymers containing alkoxysilane groups bond especially well to clear primers such as those disclosed in U.S. Pat. No. 7,416,599 incorporated herein by reference, which discloses a composition comprising a) one or more organotitanates having four ligands wherein the ligands are hydrocarbyl, optionally containing one or more functional groups having one or more heteroatoms selected from the group comprising oxygen, nitrogen, phosphorus and sulfur wherein two or more of the ligands may form a cyclic structure; b) one or more mercaptosilanes; c) one or more polyaminosilanes; d) one or more secondary aminosilanes; and e) a solvent which dissolves the components of the composition. Disclosed is a system or kit comprising the compositions disclosed and clear primers.

The composition may be used to replace windows in structures or vehicles and most preferably in vehicles. The first step is removal of the previous window. This can be achieved by cutting the bead of the adhesive holding the old window in place and then removing the old window. Thereafter, the new window is cleaned and if needed primed. The old adhesive that is located on the window flange can be removed, although it is not necessary and in most cases it is left in place, but may be cut flat with a cutting tool. The window flange is may be primed with a paint primer. The adhesive is applied in a bead to the periphery of the window located such that it will contact the window flange when placed in the vehicle. The window with the adhesive located thereon is then placed into the flange with the adhesive located between the window and the flange. Alternatively, the adhesive may be applied to the window flange. The adhesive bead is a continuous bead that functions to seal the junction between the window and the window flange. The composition disclosed may be applied to a substrate when the temperature of the composition is at or near (within 5° C. of ambient temperature). The composition may not heated before application. The composition may be applied at a composition temperature at which the composition exhibits a press flow viscosity or viscosity as disclosed herein. The composition may be applied to a substrate at a composition temperature of about −18° C. or greater, about 30° C. or greater or about 40° C. or greater. The composition may be applied to a substrate at a composition temperature of about 80° C. or less or about 70° C. or less. The composition may be heated to an appropriate temperature.

### Illustrative Embodiments of the Invention

The following examples are provided to illustrate the invention, but are not intended to limit the scope thereof. All parts and percentages are by weight unless otherwise indicated.

Testing Procedures

Press Flow Viscosity: The press flow viscosity is determined as the time (seconds) required to extrude 20 grams of adhesive through a capillary. The width of the capillary is fixed at 0.203 in (5.1 mm) and the applied pressure is 80 psi (5.5×105 Pa). Unless otherwise noted, all press flow viscosity values are determined at 23+/−1° C.

Pendulum Impact Test—determined by ASTM D256. G-Modulus is determined according to DIN 54451. Conductivity is determined according to DIN IEC 93/VDE 0303/HD 429 S1. Lap shear strength and Extension at brake are determined according to DIN 53504

Tack free time—Tack free time is determined by applying continuous triangular bead of adhesive using a commercial available applicator at maximum speed onto a polyethylene sheet on a pre-marked path. Upon the start of application a stop watch is started. A bead of 9-10 mm base and height at a rate of about 10 seconds for one traverse and about 90 seconds for a 450 ml application. At intervals of 10 seconds a clean wooden spatula is used to compress the bead up to half of its original height and then lifted up from the bead. Application of the spatula is slow and deliberate and the spatula is kept in a plane parallel to the polyethylene sheet, moved vertically down and up, so as not to disturb the bead on either side of the compressed area, at 90° angle to the direction of the bead. The working time is the elapsed time until the wooden spatula is no longer wetted out by the adhesive and rounded to the nearest half minute.

Ingredients

Prepolymer 1 a reaction product of MDI (methylene diphenyl isocyanate) and a
mixture of polyether diol and a polyether triol prepared as described in US
2010/0154969 prepolymer 1, incorporated herein by reference.
Polyester prepolymer—reaction product of diphenylmethane-4,4′-diisocyanate (MDI)
and a linear polyester diol (DYNACOL® 7360 linear polyester).
Polyfunctional polyisocyanate DESMODUR N 3300 trimer of hexamethylene
diisocyanate
Polymeric polyisocyanate having an equivalent weight of about 175, with an isocyanate functionality 3.0 and isocyanate content of 30 weight percent
fumed silica
hydrogenated castor oil derivative
alkyl quaternary ammonium clay
Carbon Black 1—non-conductive carbon black available as MONARCH 120
Carbon Black 2—conductive carbon black available under the trademark ELFTEX S7100
Clay 1—calcined kaolin clay available under the designation iceberg clay
Di-isononyl phthalate
Diethyl malonate
dibutyl tin dilaurate catalyst
dimorpholino diethyl ether
Calcium carbonate available under the trademark CARBITAL 140
Epoxy silane-gamma-glycidoxypropyltrimethoxysilane

Preparation of Adhesives. In the examples one part adhesives are prepared as follows. The polyester prepolymer is heated to melting overnight. All fillers are pre-dried. The temperature of a Molteni planetary mixer is set to 65° C. The prepolymers except the polyester prepolymer, polyfunctional polyisocyanate, plasticizer, solvent are placed in the mixer and mixed for 15 minutes under vacuum for degassing. The polyester prepolymer is introduced into the mixer with degassing for 15 minutes. Then all fillers are added and allowed to wet out for 5 minutes and mixed for another 15 minutes under vacuum. Then the catalyst is added and the mixture is mixed for 15 minutes under vacuum. After the mixture has been homogeneously mixed it is transferred into cartridges for testing and analysis. For testing, the composition is applied directly to the appropriate substrates or used as test specimens. Table 1 contains the formulations prepared as described above and the results of property testing. The 30 minute pendulum impact strength results show energy absorption levels greater than the minimum (>5500 mJ) shown in the past to pass full vehicle FMVSS 212 crash testing.

TABLE 1

| Component\Example | 1 | 2 | 3 | 4 | 5 | CE1 | CE2 | CE3 | CE4 | 6 |
|---|---|---|---|---|---|---|---|---|---|---|
| Prepolymer 1 | 56 | 56 | 56 | 56 | 56 | 55.838 | 56 | 56 | 56 | 56 |
| Diisononyl | 0.94 | 0.94 | 0.94 | 0.94 | 0.94 | 0.94 | 0.94 | 0.94 | 0.94 | 0.94 |
| phthalate | | | | | | | | | | |
| Polyfunctional | 0.5 | 0.5 | 0.5 | 0.5 | 0.5 | 1.8 | 0.5 | 0.5 | 0.5 | 0.5 |
| polyisocyanate | | | | | | | | | | |
| Polymeric MDI | 1.2 | 1.2 | 1.2 | 1.2 | 1.2 | 0.6 | 1.2 | 1.2 | 1.2 | 1.2 |
| Fumed Silica | 0.98 | 0.98 | 0.98 | 0.98 | 0.98 | 0.5 | 0.98 | 0.98 | 2.5 | |
| Carbon Black | 14.5 | 14.5 | 14.5 | 14.5 | 14.5 | 14.5 | 14.5 | 14.5 | 14.5 | 14.5 |
| Clay | 21.2 | 21.2 | 21.2 | 21.2 | 21.2 | 21.2 | 21.2 | 21.2 | 21.2 | 21.2 |
| Calcium carbonate | 2.5 | 2.5 | 2.5 | 2.5 | 2.5 | 2.5 | 2.5 | 2.5 | 2.5 | 2.5 |
| Hydrogenated | | | | | | | 2 | | | |
| castor oil | | | | | | | | | | |
| derivative | | | | | | | | | | |
| Alkyl quaternary | 2 | 2 | 1.5 | 2 | 1.5 | | | 2.5 | | 2.5 |
| ammonium clay | | | | | | | | | | |
| silane | 0.4 | 0.4 | 0.4 | 0.4 | 0.4 | 0.4 | 0.4 | 0.4 | 0.4 | 0.4 |
| Tin Catalyst | 0.03 | 0.03 | 0.03 | 0.03 | 0.03 | .022 | 0.03 | 0.03 | 0.03 | 0.03 |
| Dimorpholino | 0.55 | 0.55 | 0.55 | 0.55 | 0.55 | 0.5 | 0.55 | 0.55 | 0.55 | 0.55 |
| diethyl ether | | | | | | | | | | |
| sum | 100 | 100 | 100 | 100 | 100 | 100 | 100 | 100 | 100.82 | 100.32 |
| Testing | | | | | | | | | | |
| Press Flow 0.157 | 420 | | 234 | | | 28 | 65 | 150 | | |
| inch orifice (sec) | | | | | | | | | | |
| Press Flow 0.203 | 101 | | 53 | 49 | 28 | | | 44 | 26 | 38 |
| inch orifice (sec) | | | | | | | | | | |
| Tack Free Time | 9 | | 8 | 9 | 9.5 | 13 | 9 | 8 | 8.5 | 8 |
| (min) | | | | | | | | | | |
| Yield Stress (Pa) | 16090 | | 14219 | 10489 | 8737 | 7370 | 3031 | 12639 | 8576 | 10074 |
| G′ @100 Pa | 1.84E+06 | | 1.60E+06 | 5.50E+05 | 5.42E+05 | | 3.44E+04 | 1.28E+06 | 8.85E+05 | 8.33E+05 |
| (stress sweep | | | | | | | | | | |
| 1-1500 Pa) | | | | | | | | | | |
| 30 min | 5832 | 5956 | 5979 | 5562 | 5628 | 3673 | 5562 | 4881 | 4822 | 4904 |
| pendulum | | | | | | | | | | |
| impact strength | | | | | | | | | | |
| (mJ) | | | | | | | | | | |

What is claimed is:

1. A composition comprising
a) one or more isocyanate functional prepolymers;
b) one or more quaternary ammonium modified nanoclays having at least one dimension less than 100 nm, and present in an amount of about 0.5 to about 4.0 percent by weight based on the weight of the composition;
c) one or more catalysts for the reaction of isocyanate moieties with active hydrogen atom containing groups;
d) one or more thixotropic fillers selected from the group of coated and uncoated calcium carbonate, fumed silica, organically modified fumed silicas, polyvinylchloride powder, poly-ureas, polyamide waxes, and castor oil derivatives; and
e) one or more forms of carbon black.

2. A composition according to claim 1, wherein the one or more thixotropic fillers comprises fumed silica.

3. A composition according to claim 1 wherein the composition includes about 10 to about 60 percent by weight of a clay and/or a talc, based on the weight of the composition.

4. A composition according to claim 1, wherein the one or more thixotropic fillers are present in an amount of about 1.0 percent by weight or greater based on the weight of the composition.

5. A composition according to claim 1, wherein the one or more forms of carbon black includes conductive carbon black in an amount below the percolation threshold for the composition.

6. A composition according to claim 5, wherein the conductive carbon black is present in an amount of less than 18 percent by weight.

7. A composition according to claim 1, wherein the composition contains one or more adhesion promoters.

8. A composition according to claim 3, wherein the one or more thixotropic fillers comprises fumed silica and calcium carbonate.

9. A composition according to claim 1, wherein:
a) the one or more isocyanate functional prepolymers are present in an amount of about 20 to about 70 percent by weight;
b) the one or more quaternary ammonium modified nanoclays are present in an amount of about 0.5 to about 4.0 percent by weight;
c) the one or more catalysts for the reaction of isocyanate moieties with hydroxyl groups are present in an amount of about 0.005 to about 2 percent by weight; and
d); the one or more thixotropic fillers are present in an amount of about 0.5 to about 3.0 percent by weight or more;
e) the one or more forms of carbon black is present in an amount of 10 to 18 percent by weight; and
f) the composition includes 10 to 30 percent by weight of a clay or talc;
wherein the amounts are based on the weight of the composition.

10. A composition according to claim 1, wherein the one or more nanoclays are a mixture of nanoclays.

11. A composition according to claim 11, wherein the mixture of one of more nanoclays contain smectite.

12. A composition according to claim 11, wherein the one or more nanoclays have at least one dimension of about 50 nm or less.

13. A method of bonding a first substrate and a second substrate, comprising the steps of: contacting the first and second together with a composition according to claim 1 disposed along at least a portion of the area wherein the substrates are in contact.

14. A method according to claim 13 wherein at least the first substrate is glass or a plastic coated with an abrasion resistant coating.

15. A method according to claim 13 or 14 wherein, the second substrate is metal or plastic, which may be coated or uncoated.

16. A method according to claim 13, wherein the composition is applied to a substrate at a temperature at or near ambient temperature.

17. A method according to claim 13, wherein the composition is applied to a substrate at a temperature of about 40 to about 80° C.

18. A method of claim 15, wherein the first substrate is an automotive window and the second substrate is a window frame.

19. A composition comprising
a) about 30 to about 60 percent by weight of one or more isocyanate functional prepolymers;
b) about 16 to about 50 percent by weight of a clay and/or non-pigmented filler;
c) about 0.5 to about 4.0 percent by weight of one or more quaternary ammonium modified nanoclays having at least one dimension less than 100 nm;
d) about 0.005 to about 2 percent by weight of one or more catalysts for the reaction of isocyanate moieties with active hydrogen atom containing groups;
d) about 1 percent by weight or more of one or more thixotropic fillers selected from the group of coated and uncoated calcium carbonate, fumed silica, organically modified fumed silicas, polyvinylchloride powder, poly-ureas, polyamide waxes, and castor oil derivatives; and
e) about 10 to about 18 percent by weight of one or more forms of carbon black.

20. The composition of claim 20, wherein the non-pigmented filler is a clay and the one or more thixotropic fillers includes fumed silica and calcium carbonate.
